(19) United States
(12) Patent Application Publication
(10) Pub. No.: US 2022/0203428 A1
(43) Pub. Date: Jun. 30, 2022

(54) ADJUSTABLE HOLE PUNCH SYSTEM FOR INSTALLATION OF STANDING SEAM TYPE ROOFING

(71) Applicant: Bennie Carroll McGarity, Adkins, TX (US)

(72) Inventor: Bennie Carroll McGarity, Adkins, TX (US)

(21) Appl. No.: 16/678,080

(22) Filed: Nov. 8, 2019

Related U.S. Application Data
(63) Continuation of application No. PCT/US18/31710, filed on May 9, 2018.
(60) Provisional application No. 62/602,824, filed on May 8, 2017.

(51) Int. Cl. B21D 28/34; E04D 15/04; B26F 1/32

(52) U.S. Cl. CPC B21D 28/343; B26F 1/32; E04D 15/04

(57) ABSTRACT

A punch system for producing pilot holes through standing seam type roofing includes a punch having a striking end and a tip portion; and a punch guide that directs and controls action of the punch. The punch guide has an alignment member sized and shaped to conform to a raised rib portion of the standing seam type roofing; a tubular member affixed to the alignment member; and a force controlling mechanism contained within the tubular member and further including a punch centering sleeve, a plurality of spacers and a spring. The spacers set a stroke length for punch and sharpening of the punch is accommodated by rearrangement of the spacers.

### RELATED APPLICATIONS

This application claims priority to, and all available benefit of, P.C.T. international patent application Serial No. PCT/US18/31710 filed May 9, 2018 and U.S. provisional patent application Ser. No, 62/602,824 filed May 8, 2017. By this reference, the full disclosures, including the drawings and any claims, of P.C.T. international patent application Serial No. PCT/US18/31710 and of U.S. provisional patent application Ser. No. 62/602,824 are incorporated herein as though each was now herein set forth in its respective entirety.

### FIELD OF THE INVENTION

The present invention relates to building construction. More specifically, the present invention relates to an adjustable hole punch system specially adapted to enable proper and efficient placement of screws or like fasteners during the installation of standing seam type roofing.

### BACKGROUND OF THE INVENTION

As particularly shown in FIGS. 1 and 2, typical standing seam type roofing 41 is generally formed to comprise a plurality of elongate ribs 42, which stand up from and separate adjacent substantially flat panel areas 45. As is well known in the relevant art, properly installed standing seam type roofing 41 requires placement of screws or like fasteners through the apex 43 of a raised rib 42. As is also well know in the relevant art, standing seam type roofing 41 typically comprises aluminum or like material sheet metal, and the proper placement of the affixing hardware is difficult and time consuming at best. Notwithstanding the long felt need for improvement, little has been done to make the installation process easier or more efficient.

It is therefore an overriding object of the present invention to provide a hole punch system adapted to readily and reliably create pilot holes for proper placement of mounting hardware during installation of standing seam type roofing.

It is a further object of the present invention, however, to provide such hole punch system that is also adjustable such that sharpening of the punch may be readily achieved without compromising consistency in the formation of the desired pilot holes.

Additionally, it is also an object of the present invention to provide such a hole punch system that is economical to manufacture, easy to use and maintain, and durable in use, thereby ensuring that the benefits of the present invention may reach and effectively serve the need of the widest spectrum of potential users.

### SUMMARY OF THE INVENTION

In accordance with the foregoing objects, a punch system for producing pilot holes through standing seam type roofing according to the present invention generally comprises a punch having a striking end and a tip portion; and a punch guide adapted to direct and control action of the punch. The punch guide comprise an alignment member sized and shaped to conform to a raised rib portion of the standing seam type roofing; a tubular member affixed to the alignment member; and a force controlling mechanism contained within the tubular member, and including a punch centering sleeve, a plurality of spacers and a spring. The spacers set a stroke length for the punch and sharpening of the punch is accommodated by rearrangement of the spacers.

Many other features, objects and advantages of the present invention will be apparent to those of ordinary skill in the relevant arts, especially in light of the foregoing discussions and the following drawings, exemplary detailed description and appended claims.

### BRIEF DESCRIPTION OF THE DRAWINGS

Although the scope of the present invention is much broader than any particular embodiment, a detailed description of the preferred embodiment follows together with illustrative figures, wherein like reference numerals refer to like components, and wherein:

FIG. 1 shows, in an isometric view, a portion of standing seam type roofing, as generally typical in the prior art and of the character for which the adjustable hole punch system of the present invention is adapted to be used;

FIG. 2 shows, in a side elevational view, the portion of standing seam type roofing of FIG. 1;

FIG. 3 shows, in an isometric view, a preferred implementation of the adjustable hole punch system of the present invention;

FIG. 4 shows, in an exploded isometric view, a guide body, as forms a part of the preferred implementation of the adjustable hole punch system of FIG. 3;

FIG. 5 shows, in an exploded isometric view, various details of the preferred implementation of the adjustable hole punch system of FIG. 3;

FIG. 6 shows, in an exploded isometric view, various details of the punch and the force controlling mechanism, as form parts of the preferred implementation of the adjustable hole punch system of FIG. 3;

FIG. 7 shows, in a side elevation view, where the guide body is depicted in a cross sectional view exposing the internal components, various details of the relationships between components of the preferred implementation of the adjustable hole punch system of FIG. 3, particularly showing the components while at rest;

FIG. 8 shows, in a side elevation view, where the guide body is depicted in a cross sectional view exposing the internal components, various details of the relationships between components of the preferred implementation of the adjustable hole punch system of FIG. 3, particularly showing the components while the punch is in use;

FIG. 9 shows, in an isometric view, the preferred implementation of the adjustable hole punch system of FIG. 3 as operably placed with respect to a portion of standing seam roofing in preparation for use;

FIG. 10 shows, in a side elevational view, the preferred implementation of the adjustable hole punch system of FIG. 3 as operably being used to punch a hole through the apex of a rib of a portion of standing seam roofing;

FIG. 11 shows, in an isometric view, a portion of standing seam roofing having a hole through the apex of a rib of a portion as formed by use of the preferred implementation of the adjustable hole punch system of FIG. 3;

FIG. 12 shows, in a side elevational view, various details of the sharpening, as may be necessary, of the tip portion of the punch forming a part of the preferred implementation of the adjustable hole punch system of FIG. 3;

FIG. 13 shows, in a side elevation view, where the guide body is depicted in a cross sectional view exposing the internal components, various details of the relationships between components of the preferred implementation of the adjustable hole punch system of FIG. 3, particularly showing the components while at rest and after the tip portion of the punch forming a part of the adjustable hole has been sharpened in accordance with the present invention; and

FIG. 14 shows, in a side elevation view, where the guide body is depicted in a cross sectional view exposing the internal components, various details of the relationships between components of the preferred implementation of the adjustable hole punch system of FIG. 3, particularly showing the components while the punch is in use and after the tip portion of the punch forming a part of the adjustable hole has been sharpened in accordance with the present invention.

### DETAILED DESCRIPTION OF THE PREFERRED EMBODIMENT:

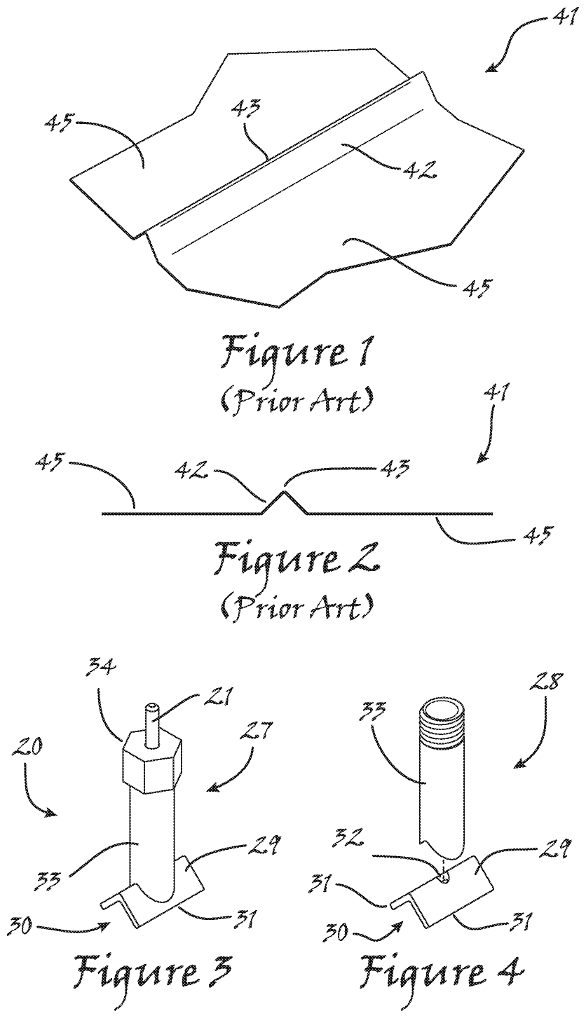

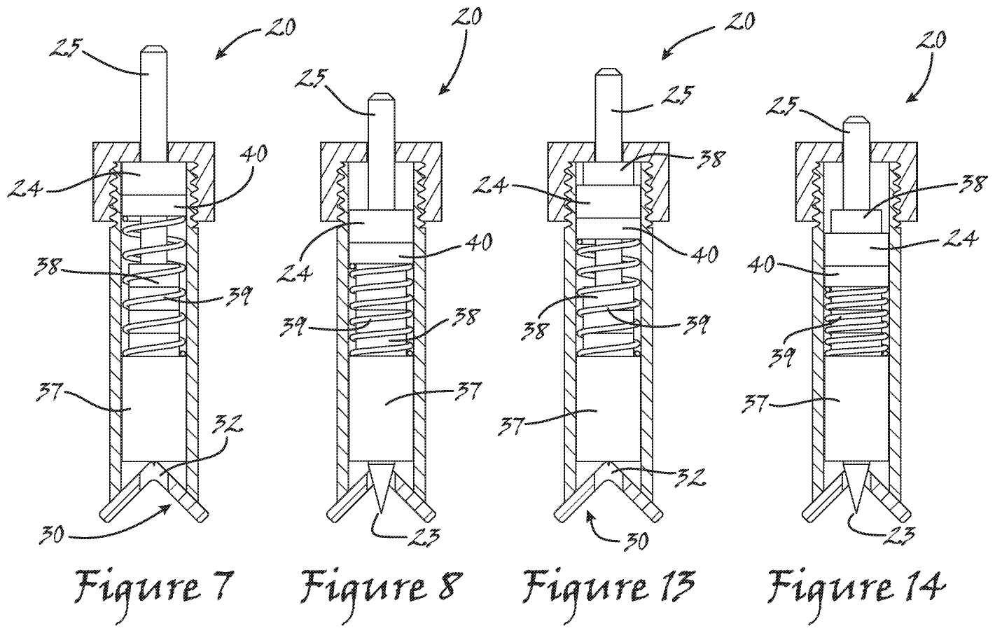

Although those of ordinary skill in the art will readily recognize many alternative is embodiments, especially in light of the illustrations provided herein, this detailed description is exemplary of the preferred embodiment of the present invention—an adjustable hole punch system 20 specially adapted to enable proper and efficient placement of screws or like fasteners during the installation of standing seam type roofing 41, the scope of which is limited only by the claims appended hereto. As shown in the figures, and in FIG. 3 through 6 in particular, the preferred implementation of the adjustable hole punch system 20 of the present invention generally comprises a punch guide 27, which directs and controls the action of a punch 21. As best shown in FIG. 6, the punch 21, which is most preferably manufactured from tempered steel or a like durable material, has tip portion 22 terminating in a metal penetrating point 23 opposite a striking end 25. In accordance with the teachings of the present invention, the punch also has a stop 24 provided between the tip portion 22 and the striking end 25. As will be better understood further herein, the stop 24 must withstand substantial force in use of the adjustable hole punch system 20, and therefore should be provided securely in place. To this end, the stop 24 may be milled as unitary part of the punch 21, welded to the punch 21 as an integral part of the punch 21, or similarly provided.

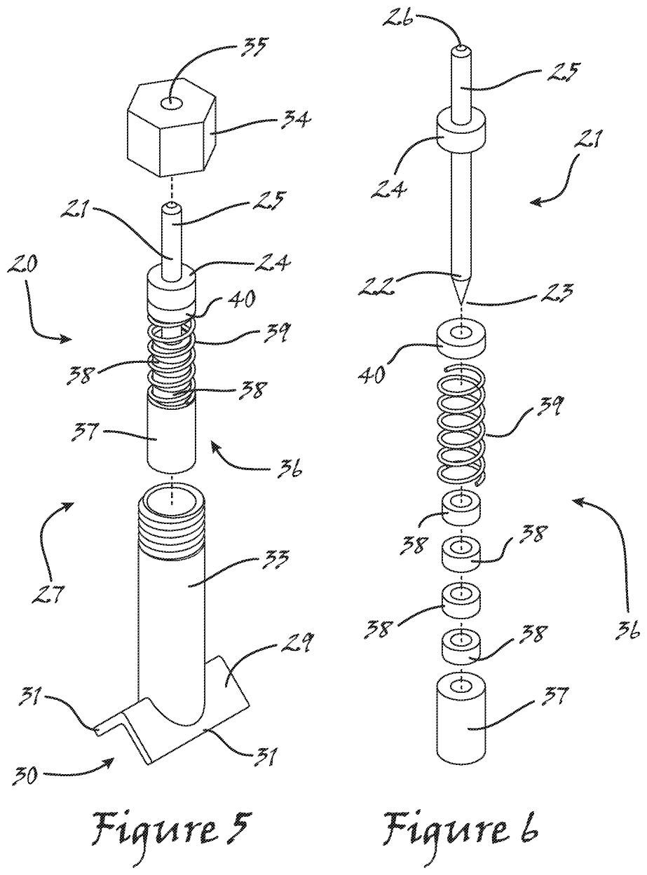

As best shown in FIG. 5, the punch guide 27 is generally formed as a guide body 28, which substantially encloses the punch 21 and a force controlling mechanism 36. As particularly shown in FIG. 4, the guide body 28 generally includes an alignment member 29 and a tubular member 33, which may readily be formed together as a steel weldment. As shown in the figures, and forming a critical aspect of the present invention, the alignment member 29 comprises a bottom surface 29 that is sized, shaped and otherwise adapted to faithfully conform to the size and shape of a raised rib 42 of the standing seam type roofing 41 with which a particular implementation of the adjustable hole punch system 20 is to be used, and an orifice 32 is is provided through alignment member 29 such that the tip portion 22 of a protruding punch 21 will be directed straight down into engagement with the apex 43 of the raised rib 42. Similarly, the lowermost edges 31 of the alignment member should be provided to engage the flat panel areas 45 of the roofing 41. In this manner, as will be better understood further herein, the adjustable hole punch system 20 is adapted to reliably center the punch 21 over the apex 42 of the raised rib 42 of the standing seam type roofing 41, while also ensuring that the raised rib 42 is not dented or otherwise damaged by the use of the adjustable hole punch system 20.

The tubular member 33 is provided with a selectively removable cap 34, as also best shown in FIG. 5. As will be better understood further herein, the cap 34 must be removed from the tubular member 33 in order to adjust the punch system 20 to accommodate the sharpening, if required, of the tip portion 22 of the punch 21. As shown in FIG. 3, however, it is noted that the striking end 25 of the punch 21 extends through an orifice 35 at the top of the selectively removable cap 34, where the striking surface 26 may be forcefully engaged with a hammer or the like in operation of the punch system 20 of the present invention. As a result, the striking end 25 of the punch 21 most preferably comprises a chamfered or like edge about the striking surface 26, thereby preventing mushrooming or the like as may otherwise make removal of the cap 34 difficult or impossible.

As best shown in FIG. 6, the force controlling mechanism 36 of the most preferred implementation of the adjustable hole punch system 20 generally includes a punch tip centering sleeve 37, a plurality of spacers 38, and a spring 39. Additionally, a further manufacturer's adjustment spacer 40 is also most preferably included. The components of the force controlling mechanism 36 are arranged about the punch 21, as depicted in FIGS. 6 and 7, and then inserted, with the punch 21, into the tubular member 33, as best shown in FIG. 7. With the components is of the force controlling mechanism 36 and the punch 21 substantially enclosed in the tubular member 33, the cap 34 is screwed or otherwise affixed in place. As will be appreciated by those of ordinary skill in the art, in light of this exemplary description, affixing the cap 34 will slightly compress the spring 39, leaving the adjustable hole punch system 20 in the configuration as depicted in FIG. 7.

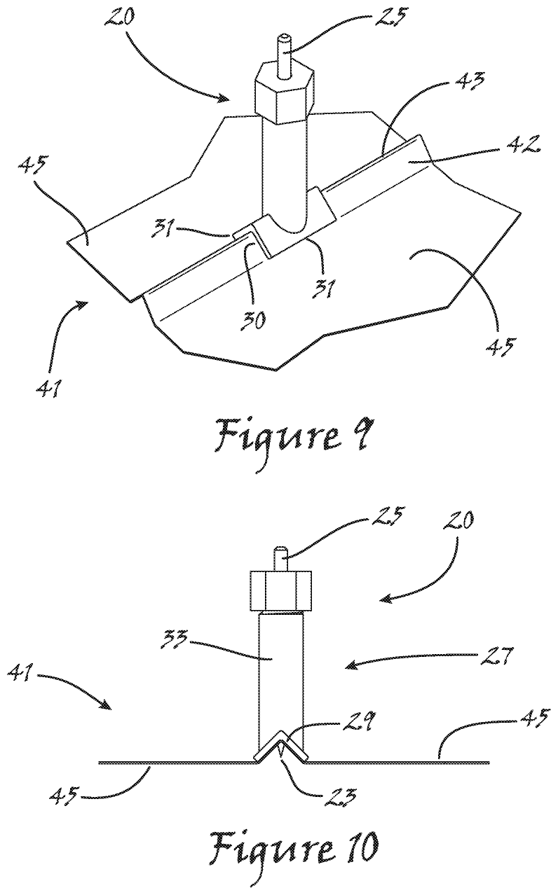

In use of the adjustable hole punch system 20 of the present invention, forcefully striking the striking end 25 of the punch 21 will cause the punch to be driven against the force of the spring 39 until the lowermost portion of the stop 24, or if provided the lowermost portion of the manufacturer's adjustment spacer 40, contacts the uppermost portion of the topmost spacer 38, as depicted in FIG. 8. As will be appreciated by those of ordinary skill in the art in light of this exemplary description, the combined thicknesses of the spacers 38 and the manufacturer's adjustment spacer 40 are thusly adapted to set and control the stoke length of the punch 21 in use of the adjustable hole punch system 20. As shown in FIG. 8, the optimal stoke length is set such that upon full impact the tip portion 22 of the punch 21 will extend downward through the central orifice of the alignment member 29 a distance causing the metal penetrating point 23 to puncture and penetrate through the apex 43 of the raised rib 42 of a portion of standing seam rooting 41 engaged by the hole punch system 20, as shown in FIGS. 9 and 10, thereby providing a properly positioned pilot hole 44 as shown in FIG. 11. In order to ensure the desired result, the manufacturer's adjustment spacer 40 is provided separate from the other spacers 38 in order that the manufacturer may select any thickness necessary, without disrupting the otherwise uniform system described further herein.

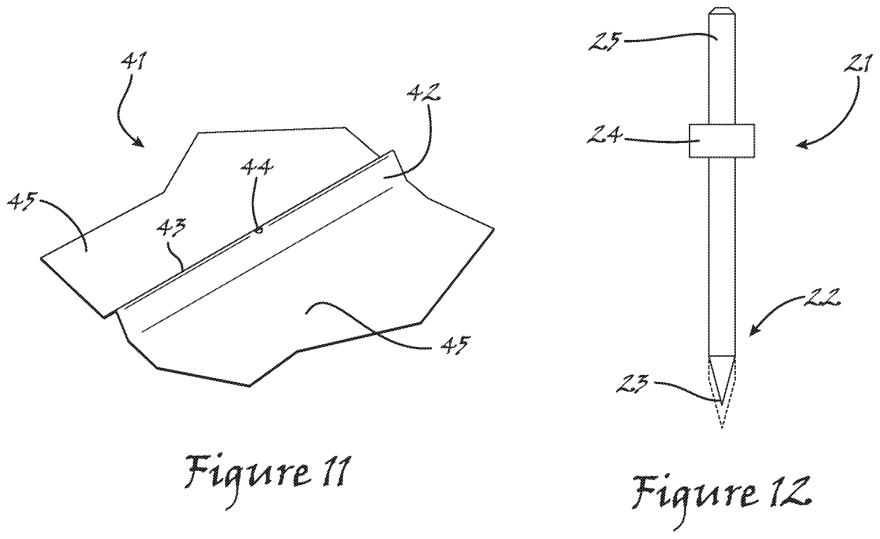

In any case, and as previously noted, the adjustable punch system 20 of the present invention is most preferably adapted to accommodate the sharpening, if required, of the tip portion 22 of the punch 21. As shown in FIG. 12, the tip portion 22 of the punch 21 is sharpened by the user taking care to shorten the overall length of the punch 21 a distance approximately equal to the thickness of one of the uniform spacers 38. Upon sharpening, as shown in FIGS. 13 and 14, the one of the uniform spacers 38 is then removed from its original location, and placed instead about the striking end 25 of the punch above the stop 24. As shown in the figures, the resulting arrangement of the adjustable punch system 20 maintains the identical stroke length for the punch 21. In an alternative arrangement, however, the total thickness of the spacers 38 may be provided by individual spacers 38 each having a different thickness. In this manner, more indiscriminate sharpening of the punch 21 may be accommodated.

While the foregoing description is exemplary of the preferred embodiment of the present invention, those of ordinary skill in the relevant arts will recognize the many variations, alterations, modifications, substitutions and the like as are readily possible, especially in light of this description, the accompanying drawings and the claims drawn hereto. In any case, because the scope of the present invention is much broader than any particular embodiment, the foregoing detailed description should not be construed as a limitation of the present invention, which is limited only by the claims appended hereto.

What is claimed is:

1. A punch system for producing pilot holes through standing seam type roofing, said punch system comprising:
a punch having a striking end and a tip portion; and
a punch guide adapted to direct and control action of the punch, said punch guide comprising:
an alignment member sized and shaped to conform to a raised rib portion of the standing sea type roofing;
a tubular member affixed to said alignment member;
a force controlling mechanism contained within said tubular member, said force controlling member including a punch centering sleeve, a plurality of spacers and a spring; and
wherein said spacers set a stroke length for said punch.

2. The punch system for producing pilot holes through standing seam type roofing as recited in claim 1, wherein sharpening of said punch is accommodated by rearrangement of said spacers.
